(19) United States
(12) Patent Application Publication
(10) Pub. No.: US 2006/0226336 A1
(43) Pub. Date: Oct. 12, 2006

(54) Apparatus and method for collecting and detecting light emitted by a lighting apparatus

(75) Inventors: Allan Brent York, Langley (CA); Shane P. Robinson, Gibsons (CA); Ian Ashdown, West Vancouver (CA); Ingo Speier, Vancouver (CA)

Correspondence Address: CHRISTOPHER J. KULISH, ESQ, HOLLAND & HART LLP, P. O. BOX 8749, DENVER, CO, 80201-8749, US

(73) Assignee: TIR Systems Ltd., Burnaby (CA)

(21) Appl. No.: 11/387,232

(22) Filed: Mar. 23, 2006

Related U.S. Application Data
(60) Provisional application No. 60/664,177, filed on Mar. 23, 2005.

(51) Int. Cl. G01J 1/44

(52) U.S. Cl. 250/206

(57) ABSTRACT

The present invention provides a method and apparatus for collecting and detecting light emitted from a plurality of light-emitting elements. The light-emitting elements are grouped into two or more clusters of one or more light-emitting elements with the clusters arranged such that a portion of the light emitted from each cluster is directly incident upon a central axis, wherein every point along the central axis is equidistant from each cluster. A light collection means also having a central axis associated therewith is placed such that the central axis of the clusters and the central axis of the collection means coincide. The light collection means collects a substantially equal portion of light from each cluster and propagates the collected light to a detection means comprising an optical sensor for conversion to an electrical signal representative of the light emitted by the clusters. The electrical signal provided by the light detection means may be fed back to a controller for use in controlling the properties of the light emitted by the light-emitting elements.

### FIELD OF THE INVENTION

The present invention pertains to the field of lighting systems and in particular to a method and apparatus for collecting and detecting light emitted from one or more light-emitting elements in order to provide features including illumination feedback control.

### BACKGROUND

Recent advances in the development of semiconductor light-emitting diodes (LEDs) and organic light-emitting diodes (OLEDs) have made these solid-state devices suitable for use in general illumination applications, including architectural, entertainment, and roadway lighting, for example. As such, these devices are becoming increasingly competitive with light sources such as incandescent, fluorescent, and high-intensity discharge lamps. Luminaries with multi-colour light-emitting assemblies of red, green, blue, amber and/or other coloured LEDs, as well as white LEDs with various colour temperatures are of particular interest for several reasons including efficiency, low cost and the ability to independently adjust the chromaticity and brightness of the light output.

One of the central problems to be addressed with LED technology is the variation of device characteristics, such as light output, dominant wavelength and forward voltage. These parameters fluctuate due to variations in manufacturing conditions. These parameters are also strongly temperature dependent. Whereas the change in parameters with temperature can be determined, the temperature dependence is not uniform for each colour. To complicate this situation even further, the device characteristics also change during the lifecycle of LEDs.

In order to control the light output of an LED based luminaire, the total delivered light must be monitored accurately. This requires placing light sensors, for example photodiodes or other forms of light detection devices, in such a manner that a known fraction of the light intensity from each light source intercepts one or more of the sensors. In addition, the amount of sensed light must be sufficient enough to ensure satisfactory signal-to-noise ratio for the operation of a feedback loop in order to control the functionality of the light sources.

For example, U.S. Pat. No. 6,741,351 discloses a method for positioning one or more red, green, or blue photodiodes for detection of light from an LED luminaire comprising an array of red, green and blue LEDs. An equal fraction of light is sampled from each LED in order for the total light output to be monitored accurately, which is performed using a reflecting element to redirect light from the LEDs to the photodiodes. Individual colours are measured sequentially by pulsing the LEDs and then using particular photodiodes, or colour filters in combination with photodiodes, for detecting the light from the LEDs. The arrangement of the LEDs and the optics, however, can result in the optical path lengths between the LEDs and the photodiodes being relatively large which may result in inaccuracies in the detected signal. Furthermore, this arrangement results in a relatively large overall size of the luminaire.

U.S. Pat. No. 6,803,732 describes an LED array having a plurality of LED chains, which each have at least one LED and are connected in parallel. The LED array has at least one output for feeding back radiation generated to a power supply unit. At least one reference LED chain is connected in parallel with the LED chains and a photosensitive component is provided, the photosensitive component detecting the radiation emitted by the reference LED chain. The photosensitive component generates a measurement signal in a manner dependent on the radiation generated by the reference LED chain, which signal serves for providing feedback to the power supply unit.

U.S. Pat. No. 6,498,440 describes an illuminator assembly that is capable of utilizing a plurality of light sources to produce a desired resultant hue, and includes a processor, a memory, a plurality of light sources and a detector. The memory is coupled to the processor and stores data and information. Each of the plurality of light sources are coupled to the processor and produce a different color. The processor is capable of independently controlling the intensity of each light source so as to produce a desired resultant hue. The detector is also coupled to the processor. The detector provides the processor with information which the processor utilizes in determining how to adjust the intensity of each of the light sources to provide the desired resultant hue.

U.S. Pat. No. 6,614,358 describes a solid state light apparatus ideally suited for use in traffic control signals provided with optical feedback to achieve a constant light output, preferably by detecting back-scattered light from a diffuser centered above an LED array. The control logic allows for the LEDs to be individually driven, and having their drive characteristics changed over time to ensure a uniform beam of light is generated at an intensity meeting DOT standards, across the life of the device. The optical feedback also establishes the uniform beam intensity level as a function of sensed ambient light to discern day and night operation.

United States Patent Application No. 20030087231 describes a method of controlling power provided to one or more light emitting diodes in a projection system comprising measuring light output from the one or more light emitting diodes. Based at least upon the measured light output, the power to at least one of the light emitting diodes is modified.

U.S. Pat. No. 6,689,999 describes a light emitting diode lighting apparatus that includes: a power supply for providing a fixed direct current; a light emitting diode head for emitting light; and a controller for adjusting the level of said light output on said head and compensating for efficiency altering effects of said light in said power head, whereby said controller receives signals for optical feedback stabilization, temperature compensation, and detection of short term current changes to adjust said light and efficiency.

U.S. Pat. No. 5,783,909 describes a circuit for maintaining the luminous intensity of a light emitting diode (LED) comprising at least one light emitting diode (LED) for producing an luminous intensity; a sensor for sensing a condition proportional to the luminous intensity of the LED and for producing a luminous intensity signal; a power supply electrically connected to the LED for supplying pulses of electrical energy to the LED; and wherein the power supply includes a switching device responsive to the luminous intensity signal for adjusting the electrical energy supplied by the pulses per unit of time to adjust the average of the current passing through the LED to maintain the luminous intensity of the LED at a predetermined level. In one instance, the sensor includes means for sensing changes in the operating temperature of the LED. In a second instance, the sensor includes means for sensing changes in luminous output of the LED. The electrical energy supplied by the pulses per unit of time are adjusted by any one of varying the frequency, varying the width of the pulses, a combination of frequency and width, or adjusting the phase of the pulses within an AC sinusoidal wave form.

U.S. Pat. No. 5,471,052 describes a sensor system for recognition of the colour of an object using two or more primary light sources of different characteristic chromaticity and one primary photosensitive element which receives light from the light sources after it has reflected off the target object and a secondary photosensitive element which receives light from the light sources prior to reflection off of the target. The colour of the light of the primary light sources is determined along with the light reflected from the object. Adequate processing of the two signals yields the colour of the object. Alternatively, the reflected light can be used in a feedback loop to control the primary light sources. Light emitted from the light sources is carried to the object using a fibre-optic bundle which may be split off and directed to a secondary receiver that measures the light and uses the signal to regulate the output of the light sources. The secondary receiver may also be placed in a light box with the light sources. Again, both the fibre-optic bundle as well as having the sensor directly across from the light sources can result in the overall size of the system being undesirably large.

U.S. Pat. No. 5,838,451 describes an apparatus with solid-state emitters and detectors for measuring the spectral intensity distribution of light reflected from or transmitted through objects. Similarly, in this invention optics are used to redirect light before it is incident upon the detectors. In addition, the embodiments of this invention employ a temperature based feedback loop for controlling the light emitted by the solid-state emitters which can require elaborate calibration of the system components.

U.S. Pat. No. 6,127,783 describes a white light luminaire with LEDs in each of the colours red, green, and blue. An optical fibre collects a portion of the light emitted by the LEDs and directs it to a photodiode that provides input for a feedback control circuit that controls the electric current through the LEDs. The control circuit turns off the LEDs for the colours not being measured in a sequence of time pulses and compares the measured light output for each colour to a desired output. With this arrangement, the path length between each LED and the photodiode can significantly vary thus resulting in inaccuracies in the detected signals.

U.S. Pat. No. 5,739,915 describes an electro-optical system that is devised for scanning a color document into electrical signals for reproduction of the color document. The electro-optical system comprises a white light source for generating a beam of white light for illuminating the color document being scanned. A self-focus lens array consisting of at least a first row, a second row, and a third row of rod lenses is used to focus the reflected light from the color document onto a linear photosensor array. To separate the reflected light into RGB components, a first strip of red filter film is attached to one end of the first row of rod lenses; a second strip of green filter film is attached to one end of the second row of rod lenses; and a third strip of blue filter film is attached to one end of the third row of rod lenses. The light passing through the self-focus lens array causes the linear photosensor array to generate electrical signals representative of the amounts of the red, green, and blue components in the reflected light. The color filter films are low-cost and easy to assemble, allowing the manufacture cost for the electro-optical system to be significantly reduced.

While there are many prior art methods and systems for collecting illumination generated by light sources such as LEDs, the design of these prior art systems are typically complicated and can have inaccurate detected signals. Therefore there is a need for a new method and apparatus for collecting and detecting light from light sources for use in, for example, feedback and control of the light sources.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus and method for collecting and detecting light emitted by a lighting apparatus. In accordance with an aspect of the present invention, there is provided a lighting apparatus configured for light collection and detection, and adapted for connection to a source of power, said lighting apparatus comprising: two or more clusters of one or more light-emitting elements for emission of light, said clusters arranged around a first central axis and each cluster is substantially equidistant from said first central axis; light collection means for collection of a portion of the light emitted by each of the two or more clusters, said light collection means having a second central axis said light collection means positioned to align said second central axis with said first central axis; and light detection means optically coupled to the light collection means, said light detection means for receiving said portion of light and conversion of said portion of light to an electrical signal representative of said light.

In accordance with another aspect of the present invention there is provided a method for collecting and detecting light emitted by two or more clusters of light-emitting elements, said method comprising the steps of: providing a light collection means optically coupled to the two or more clusters and a light detection means optically coupled to the light collection means, said two or more clusters arranged around a first central axis and each cluster substantially equidistant from said first central axis, said light collection means having a second central axis and said light collection means positioned to align said second central axis with said first central axis; collecting a portion of light emitted by each of said two or more clusters of light emitting elements using said light collection means; and detecting said portion of light and converting said portion of light to an electrical signal representative of said light using said light detection means.

### BRIEF DESCRIPTION OF THE FIGURES

FIG. 1 illustrates a top view of an arrangement of clusters and an optical sensor according to one embodiment of the present invention.

FIG. 2 illustrates a top view of an arrangement of clusters and optical sensors according to another embodiment of the present invention.

FIG. 3A illustrates a cross sectional view of a system for collecting and detecting light according to one embodiment of the present invention.

FIG. 3B illustrates a top view of the embodiment of FIG. 3A.

FIG. 4A illustrates a cross-sectional view of a system for collecting and detecting light according to another embodiment of the present invention.

FIG. 4B illustrates a top of the embodiment of FIG. 4A.

FIG. 5 illustrates a cross sectional view of a system for collecting and detecting light according to another embodiment of the present invention.

FIG. 6 illustrates a cross sectional view of a system for collecting and detecting light according to another embodiment of the present invention.

FIG. 7 illustrates a cross sectional view of a system for collecting and detecting light according to another embodiment of the present invention.

FIG. 8 illustrates a cross sectional view of a system for collecting and detecting light according to another embodiment of the present invention.

FIG. 9A illustrates a cross sectional view of a system for collecting and detecting light according to another embodiment of the present invention.

FIG. 9B illustrates a top view of FIG. 9A.

FIG. 10 illustrates a perspective view of an optical element for redirecting collected light to an optical sensor and rejecting ambient light, according to one embodiment of the present invention.

FIG. 11 illustrates a cross sectional view of a portion of a system for collecting a detecting light according to one embodiment of the present invention.

FIG. 12 illustrates a close-up of the optical element of FIG. 10 coupled to an optic associated with a cluster of light-emitting elements.

FIG. 13A illustrates a first longitudinal cross sectional configuration of a light collection and redirection optic according to an embodiment of the present invention.

FIG. 13B illustrates a second longitudinal cross sectional configuration of a light collection and redirection optic according to an embodiment of the present invention.

FIG. 13C illustrates a third longitudinal cross sectional configuration of a light collection and redirection optic according to an embodiment of the present invention.

FIG. 14 illustrates a cross sectional view of a system for collecting and detecting light according to another embodiment of the present invention.

### DETAILED DESCRIPTION OF THE INVENTION

Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The terms “light” and “colour” are used interchangeably to define electromagnetic radiation of a particular frequency or range of frequencies in a particular region or combination of regions of the electromagnetic spectrum for example, the visible, infrared and/or ultraviolet regions.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by someone of ordinary skill in the art to which this invention belongs.

The present invention provides a method and apparatus for collecting and detecting light emitted from a plurality of light-emitting elements. The light-emitting elements are grouped into two or more clusters of one or more light-emitting elements with the clusters arranged such that a portion of the light emitted from each cluster is directly incident upon a central axis, wherein every point along the central axis is equidistant from each cluster. The light-emitting elements within each cluster are typically placed close to each other relative to the distance between each cluster. The optical path length of the light from each light-emitting element incident on each point along the central axis is substantially equal for all light-emitting elements of the clusters. A light collection means also having a central axis associated therewith is placed such that the central axis of the clusters and the central axis of the light collection means coincide. The light collection means collects a substantially equal portion of light from each cluster and propagates the collected light to a light detection means comprising one or more optical sensors for conversion to an electrical signal representative of the light emitted by the clusters. The present invention therefore provides a substantially equal optical path length from each cluster to the light detection means and may ensure that the light collection means propagates a substantially equal portion of light from each cluster to the light detection means.

In one embodiment, the electrical signal provided by the light detection means can be fed back to a controller for use in controlling the properties of the light emitted by the light-emitting elements, for example. As would be readily understood, calibration of the controller may be required in order to determine the properties such as flux, chromaticity and colour temperature of the light emitted by the two of more clusters from the electrical signal obtained from the light detection means.

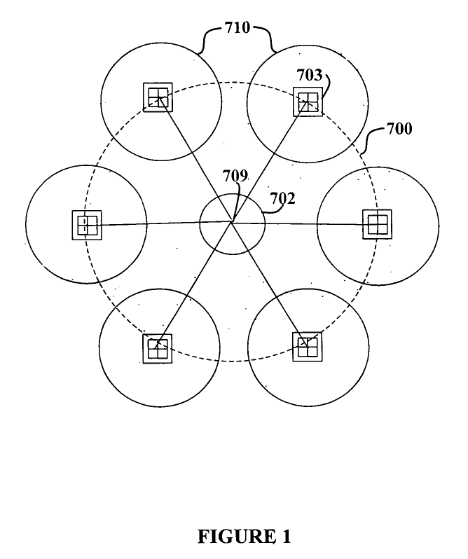

For example, as illustrated in FIG. 1, six clusters 710 of light-emitting elements 703 may be arranged in a circular design resulting in the distance between each point on an axis passing through the centre 709 of the circle 700, being equidistant from each cluster. An optical sensor 702 is placed on the axis perpendicular to the plane of clusters through the centre 709 of circle 700 and is used to both collect and detect the light emitted from clusters 710.

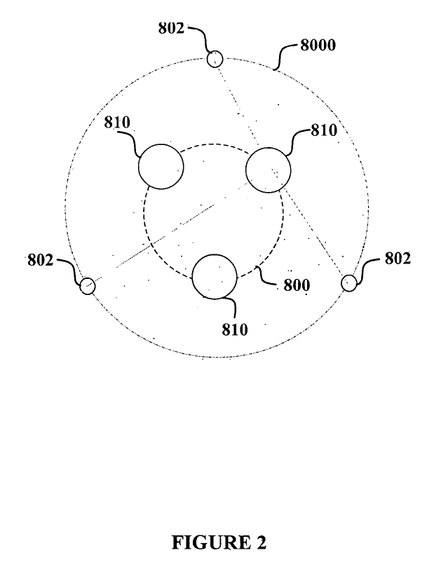

FIG. 2 illustrates another example of an arrangement of clusters according to the present invention wherein light-emitting element clusters 810 are arranged in a circular design with an angular separation of 120° between each cluster and optical sensors 802 are arranged around circle 800 also in a circular design with an angular separation of 120° between each optical sensor. The central axis of each of circles 800 and 8000 coincide and pass through the centre of each other. Thus, although each individual optical sensor may collect different portions of light from each cluster 810, optical sensors 802 together as a group collect substantially equal portions of light from each of clusters 810. Other arrangements of clusters and optical sensors, which can ensure substantially equal portions of light from each cluster are collected by a group of optical sensors, would be readily understood by a worker skilled in the art.

As would be readily understood, numerous arrangements of the light-emitting element clusters, light collection means and light detection means are possible. The light-emitting elements are activated by a source of power and a controller may be used to control the level and type of power which subsequently controls the properties such as the luminous flux, radiant flux and chromaticity, for example, of the light emitted from the light-emitting element clusters.

The present invention may reduce the number of light detection means, for example optical sensors, by detecting the light from all of the clusters together instead of using a polling method as is common in the current state of the art. This simplification of a light detection means can provide a reduction in the cost of manufacturing and parts.

The arrangement of clusters of light-emitting elements according to the present invention is that the path length between the light-emitting elements and one or more optical sensors can be made small thus enabling stray light, or other effects that may cause inaccuracies in the detection of light to be reduced, for example. In addition, embodiments of the present invention can enable the number of components and thus the overall size of the lighting system to be reduced, for example by placing an optical sensor proximate to or on the central axis of the clusters. Furthermore, embodiments of the present invention allow the clusters of light-emitting elements, one or more optical sensors and any feedback loop circuitry to be implemented on a single substrate such as a printed circuit board (PCB). Additionally, by using a single optical sensor for light detection, a feedback loop developed thereupon may be quicker than a feedback loop defined by the use of polling methods.

The light-emitting elements may be of various types, for example they may be LEDs, small molecule organic LEDs (OLEDs), polymer LEDs (PLEDs), or any other primary or secondary emission light-emitting element as would be readily understood. The light-emitting elements within a cluster may emit various colours, for example, each cluster may contain red, green, and blue or red, green, blue and amber light-emitting elements for production of white light or the light-emitting elements may also emit white light of various colour temperatures, for example phosphor coated LEDs.

Light Collection

In one embodiment of the present invention, the light collection means may comprise optics or other means for performing one or more of extracting, collecting and guiding light from the clusters of light-emitting elements to the light detection means. In one embodiment, the light from the clusters of light-emitting elements may be directly incident on a point on the central axis on which the detection means is placed, wherein this point can be defined by the arrangement of the clusters. In one embodiment, light may be collected by the optical sensor, and thus, the optical sensor provides both the collection means and detection means.

In another embodiment the light from the light-emitting elements may be directed towards a point on the central axis defined by the arrangement of clusters and then subsequently redirected to the light detection means. For example, light from the clusters may be incident on a window coincident to a point on the central axis defined by the arrangement of the clusters and then subsequently guided to an optical sensor removed from that location.

In one embodiment the clusters of light-emitting elements comprise additional optics for directing light in various desired directions. Cluster optics associated with the clusters may determine the amount of light collected by the light collection means. In one embodiment of the present invention, the cluster optic may comprise a dielectric total internal reflection type collector (DTIRC) such as a compound parabolic collector (CPC), or may comprise a mirror type reflective optic such as a reflective CPC, or may comprise a light pipe, or a combination of reflective, DTIRC and refractive or other optics as would be readily understood by a worker skilled in the art. Where a DTIRC or other such optic is used, for example, light leaking out of the sides of the optic can be sufficient to provide adequate radiant intensity levels of the light emitted by the clusters to enable both collection and detection.

In one embodiment, where for example higher light levels are required, the DTIRC or other cluster optic can be designed such that at a desired location a “defect” or integrated feature in the cluster optic can be created that directs light towards the light detection means or increases the level of light leaking out of the optic, for example. The integrated feature fabricated in the cluster optic, may be moulded in the cluster optic, or may be machined into the cluster optic or attached to the cluster optic, for example.

In one embodiment, the light collection means may be wholly or partially integrated with the cluster optics. In one embodiment, the light collection means comprises a light extraction optic configured to mate with the cluster optic for extraction of a portion of the light emitted by the light emitting elements of the cluster. The light extraction optic may direct the portion of light directly to the light detection means.

In one embodiment, the light collection means comprises a light extraction optic optically coupled with the cluster optic for extracting a portion of the light generated by the light emitting elements. The light collection means further comprises a light collection optic optically coupled to the light extraction optic, wherein the light collection optic collects the portion of light and guides it to the light detection means.

In one embodiment a sample of the light emitted by the clusters can be gathered using a light collection means comprising a light collection optic or light collection optical system that is optically coupled to the clusters and is designed to pick up a small amount of light from each cluster and guide the light to the light detection means such that substantially equal amounts of light from each cluster are incident upon the light detection means. This light collection optic can be a solid or hollow light pipe, can have refractive and/or reflective optical elements and can have diffuse or specular reflecting surfaces, for example. This light collection optic can provide a means for collecting and guiding the light to the light detection means. In one embodiment of the present invention, this separate light collection optic can further mix the collected light.

In one embodiment of the present invention, an optical element for example a lens, positioned within the light collection optic can be used to provide a means for concentrating and/or focusing the light collected by the light collection optic onto the light detecting means. This process of concentration may increase the amount of light incident upon the light detecting means which may thereby increase the accuracy of the light detecting means.

In one embodiment, the optic positioned within the light collection optic can directly re-image the exit aperture of the light collection optic onto the light detecting means thereby reducing noise levels and increasing light flux onto the light detecting means.

In another embodiment of the present invention, a filter can be positioned at a position along the length of the light collection optic. For example, this filter can be positioned at the top, bottom or middle of the light collection optic. The filter can be a neutral filter to reduce the overall signal level or a selective filter such as an infrared filter, ultraviolet filter, or colour filter to selectively block regions of the electromagnetic spectrum. The selection of the filter type can be based on the desired filtering capabilities thereof and the requirements of the specific application, for example the type of optical sensor. For example, daylight and light emitted by incandescent and fluorescent sources contains significant infrared content that can affect the light detection means, and therefore suppression using an infrared filter may be desired.

In one embodiment, a filter can be incorporated into the light detection means. For example a silicon photodiode with colour filter coatings for red, green, blue, amber or infrared radiation can be used to detect selected portions of the collected light.

In one embodiment of the present invention, a single light extraction optic may be configured to be common to one or more of the clusters of light-emitting elements. For example, in a luminaire comprising a plurality of clusters, a single light extraction optic may be used to shape the beam of light emitted from each of the clusters and sample the light emitted by each of the clusters. In one embodiment, this light extraction optic may be used to support all or part of the light collection optic or form a part of the light collection optic.

In one embodiment of the present invention the light collection means comprises a light blocking element, for example an optic or other structure, that may be used to limit the detection of ambient light. For example, an opaque or reflective element may be placed such that all or part of the ambient light is prevented from entering the light collection optic and/or prevented from reaching the optical sensor.

In one embodiment of the present invention the light collection means comprises an optical element configured to both extract light from the clusters and block ambient light from reaching the light detection means. In one embodiment this optical element can be formed from a transparent material with an opaque coating on the top surface thereof. In one embodiment, the optical element can be positioned to extract and guide light from the cluster optics associated with the clusters into the light collection optic. The reflective opaque coating on the top surface of this optical element can be configured to reflect light from the clusters into the light collection optic and towards the light detection means, while rejecting ambient light.

Light Detection

Various types of optical sensors may be used as the light detection means which is capable of detecting the light from the clusters. For example, the optical sensors may be semiconductor photodiodes, photosensors, LEDs or other optical sensors, as would be readily understood by a worker skilled in the art. In addition, an optical sensor may be configured to detect light of one or more frequency ranges.

Different optical sensors may be used to detect light of different frequency ranges, for example, a particular optical sensor sensitive to red light may be used to detect the red portion of light emitted from the clusters, while other optical sensors sensitive to green or blue light may be used to detect the green or blue portions of light, respectively. Furthermore, one or more colour filters may be used to select a specific wavelength range for direction towards the optical sensor. A filter may be positioned over the light detection means, for example a silicon photodiode.

In one embodiment the light detection means may comprise more than one optical sensor for the conversion of light from one or more clusters of one or more light-emitting elements to an electrical signal. The optical sensors may be placed at any desirable location for example at any point along or around the central axis defined by the arrangement of the clusters, at more than one point on or around this central axis, inside a substrate on which the clusters are mounted, peripheral to the clusters, or at another location in the same plane or alternate plane as the clusters.

In one embodiment the optical sensor may both collect and detect the light emitted by the one or more clusters of light-emitting elements. In addition, the positioning of the optical sensor can take advantage of any symmetry in the cluster arrangement thereby eliminating the need for additional light collection optics.

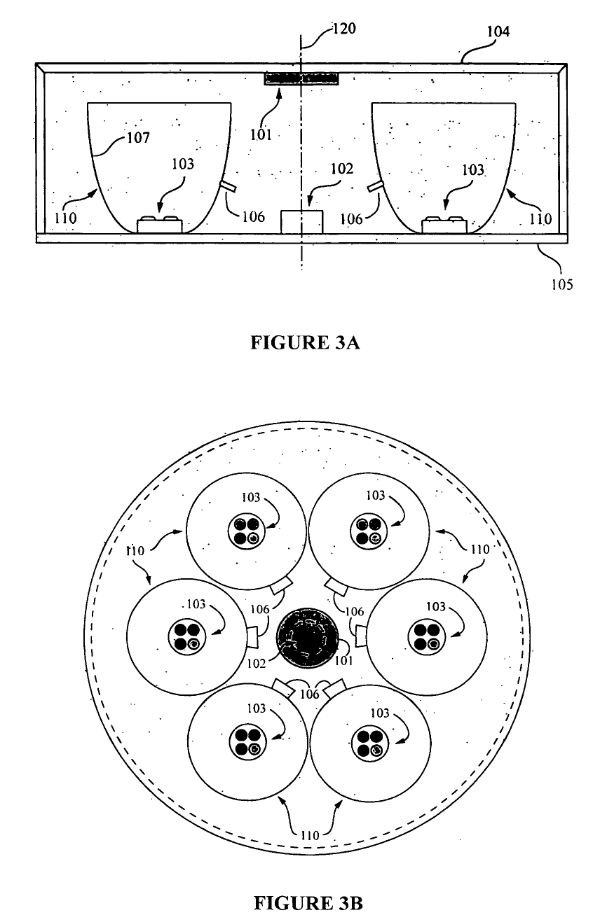

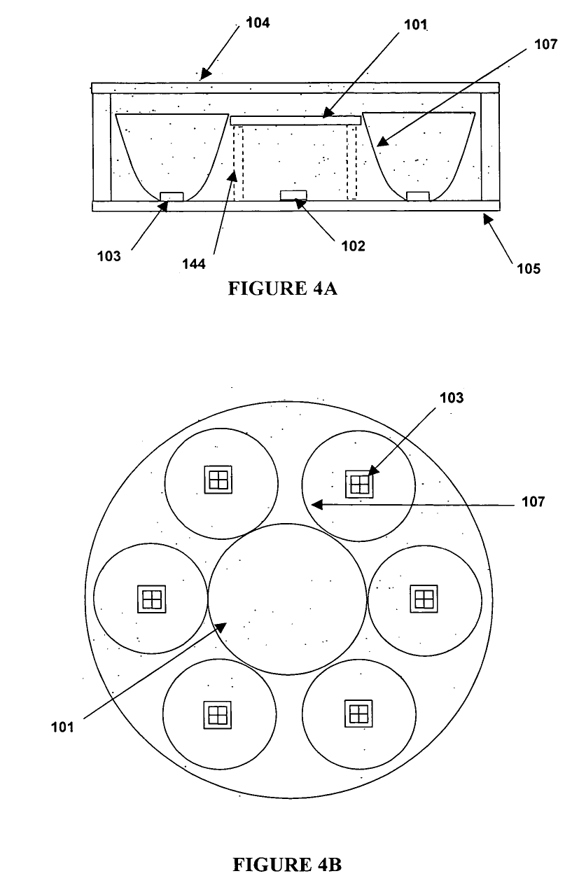

FIG. 3A and FIG. 3B illustrate one embodiment of the present invention wherein FIG. 3A illustrates a cross-sectional view and FIG. 3B illustrates a top view thereof. Clusters 110 comprising four light-emitting elements 103 are arranged in a circular design and optical sensor 102 is placed over a point along the central axis defined by the arrangement of the clusters, on the same substrate 105 as the clusters of light-emitting elements. Each cluster 110 has a cluster optical element 107 associated therewith for directing the light from the light-emitting elements 103 towards the output window 104 which may comprise a diffuser. An additional light extraction optical element 106, for example a designed defect or light guide or light reflective tube, can increase the extraction of light from the light-emitting elements 103 and direct the light extracted from the cluster such that a sufficient portion of light is incident on optical sensor 102. The cross-sectional view and top view of an embodiment without a light extraction optical element is illustrated in FIG. 4A and FIG. 4B, respectively.

In one embodiment, a predetermined portion or all of the cluster optical element 107 is made of a transparent material such as acrylic or any other polymeric material and therefore light extraction optical element 106 may not be required as light may leak out the cluster optic through the transparent material and become incident upon optical sensor 102.

In one embodiment, light extraction optical element 106 may not be required if the cluster optical element 107 is designed to have a defect, for example a machined or moulded hole, at a desired location thus enhancing the extraction of light from the light-emitting elements 103. Substrate 105 may be a PCB, for example, and may comprise a feedback loop for feeding the signal from optical sensor 102 to control circuitry (not shown) of the light-emitting elements, which may be present on the substrate 105.

In one embodiment, to protect the optical sensor from ambient light, an opaque element 101 is coupled to the underside of the output window 104 as illustrated in FIG. 3A. The opaque element 101 may be located anywhere along the axis 120 between the optical sensor 102 and the output window 104 provided that it can be supported and such that it does not interfere with the optical path between the optical sensor 102 and the light extraction optical elements 106. FIG. 4A illustrates a support structure 144 for supporting the opaque element 101 below the level of the output window 104. Where the intensity of the ambient light is sufficiently small, the opaque element 101 may not be required.

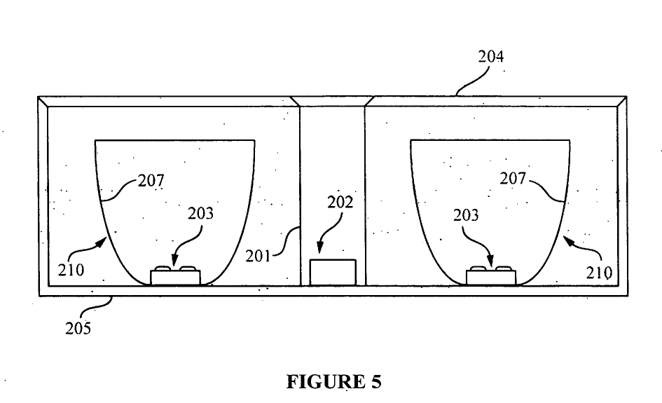

FIG. 5 illustrates another embodiment of the present invention, wherein a window 204 captures a fraction of light emitted from clusters 210 on substrate 205 and is optically connected to a light-extracting element 201, such as a light pipe, for example. Some of the light from clusters 210 propagates inside window 204 and the centrally aligned light-extracting element 201 extracts a portion of this light and guides it to optical sensor 202. In this way, light from clusters 210 is directed to the optical sensor 202 and thus collected and detected. Cluster optic 207 associated with each of the clusters can provide collimation of the light produced by the light-emitting elements, thereby forming a light beam, for example. The optical sensor 202 converts the detected light to an electrical signal which is representative of the incident light which provides an indication of the intensity of light emitted by the clusters 210. This signal may be fed back to the control circuitry of the light-emitting elements 203 within the clusters 210. An opaque element may be placed above window 204 and optical sensor 202 in order to block ambient light entering the optical sensor directly.

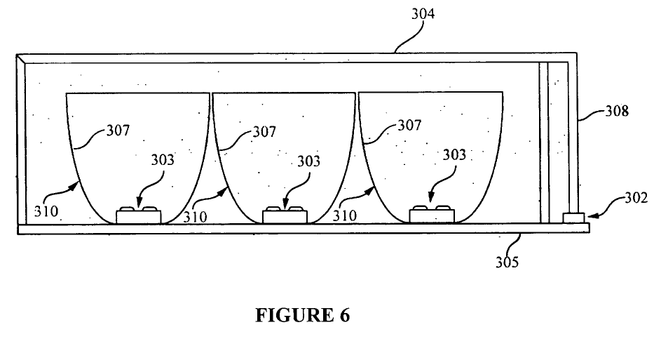

FIG. 6 illustrates another embodiment of the present invention, wherein clusters 310 are geometrically arranged and light from the light-emitting elements 303 is shaped into a light beam by a cluster optic 307. A window 304 that may further comprise an additional beam shaping element such as a diffuser is placed above cluster optic 307. While most of the light passes through window 304, some of this light can be trapped in the window and propagated along the window. A light guide 308 such as a hollow or solid light pipe, for example, can subsequently guide the light to an optical sensor 302 on substrate 305. As a result of this arrangement of the clusters 310 a substantially equal amount of light is collected in the window 304 from each light-emitting element 303 and directed to optical sensor 302.

In one embodiment, more than one optical sensor may be placed peripheral to the clusters with a constant angle between each optical sensor from the central point. For example three optical sensors may be placed 120° apart. The placement of the optical sensors in such a configuration can provide a relatively equal light contribution from each cluster to the overall signal when compared to a single optical sensor detecting the collected light.

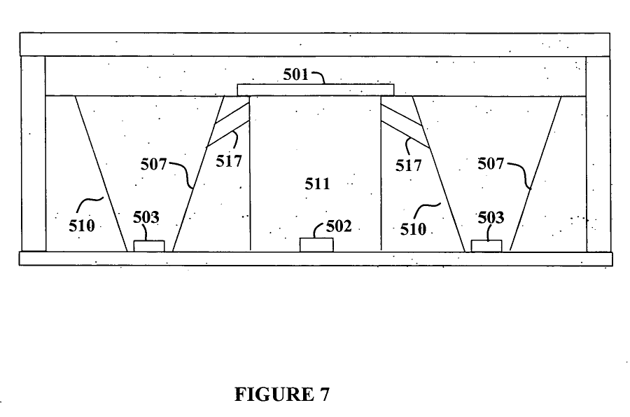

FIG. 7 illustrates another embodiment of the present invention, wherein clusters 510 are geometrically arranged and cluster optical elements 507 surrounding the light-emitting elements 503 are made from an opaque material. The opaque material may be coated with a reflective material in order to direct the light efficiently. A hole, that may be drilled or machined channel, is present in each cluster optical element 507, such that a portion of light from light-emitting elements 503 is allowed to enter a light collection optic 511 via a light guide 517 associated with the hole. The light guide 517 may be positioned such that it allows light generated by light-emitting elements 503 to reach the light collection optic 511 while reducing the effect of ambient lighting. The walls of light guide 517 may be diffuse or specular reflective. The light collection optic 511 can be covered on top by an optical element 501 configured to prevent ambient light from entering the light collection 511. The light collection optic can provide a means for directing the collected light towards the optical sensor and in one embodiment the light collection optic can additionally provide a means for further mixing the collected light. Optical element 501 may further be designed to direct light towards optical sensor 502, for example. Furthermore, a filter or other means as would be readily understood may be used in conjunction with the optical sensor to reduce the overall flux or flux within a specific spectral range and thus adjust the illuminance levels detected by the optical sensor.

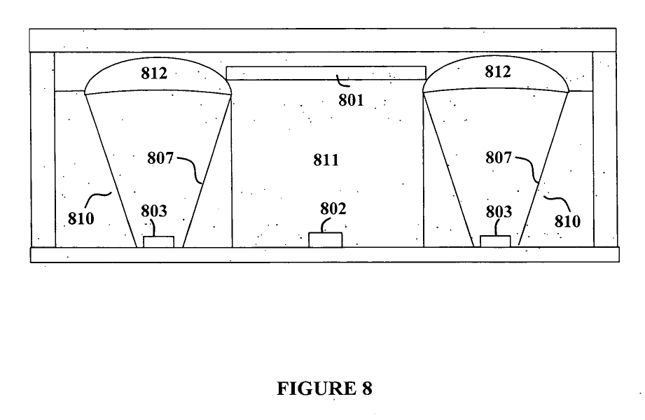

FIG. 8 illustrates another embodiment of the present invention, wherein clusters 810 are geometrically arranged and cluster optical elements 807 surrounding light-emitting elements 803 are made from an opaque material and a transparent lens 812 can be positioned on top of each cluster. A small amount of light can leak out of the edges of each lens 812 and can be transmitted down to an optical sensor 802 centred inside a light collection optic 811. The lens 812 may be contained in a mounting ring having a clearance to allow some of the light trapped therein to leak out from the edge of the lens into light collection optic 811. The light collection optic 811 can be covered on top by an optical element 801 configured to prevent ambient light from entering the light collection optic. The light collection optic can provide a means for directing the collected light towards the optical sensor and in one embodiment the light collection optic can additionally provide a means for further mixing the collected light. Optical element 801 may further be designed to direct light towards optical sensor 802, for example. Similarly, all the walls of light collection optic 811, including optical element 801 positioned on the top of the light collection optic, can be diffuse or specular reflective and shaped as desired. As a result of the arrangement of the clusters 810, a substantially equal amount of light can be collected from each light-emitting element 803 and directed to optical sensor 802.

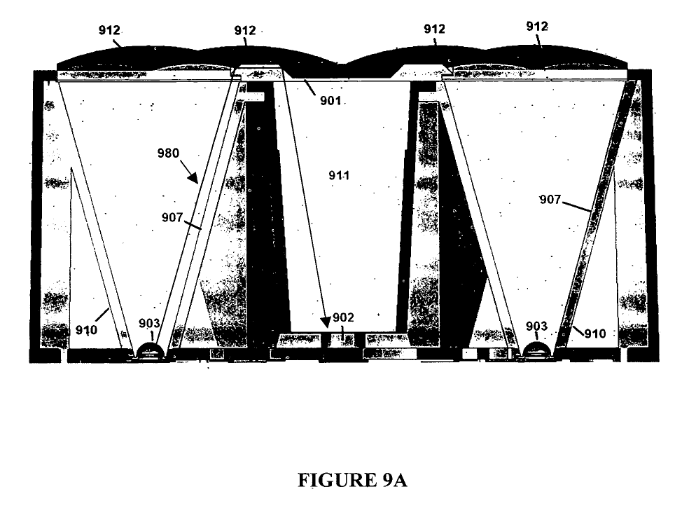

FIG. 9A and FIG. 9B illustrate another embodiment of the present invention, wherein clusters 910 are geometrically arranged and optical elements 907 surrounding light-emitting elements 903 are made from an opaque material. Cluster optical element 907 provides a means for collimating and mixing the light generated by the light-emitting elements. A transparent lens 912, for example a plano-convex lens, can optionally be positioned on top of the cluster optical element 907 associated with each cluster. Light extraction optical element 901 is made from a transparent material with a reflective coating on the top surface thereof. The light extraction optical element 901 can interface with the lenses 912 and mate with the output aperture of cluster optical elements 907 thereby sampling a portion of light from each cluster which can be representative of the chromaticity and luminous flux of the emission of each cluster. The light extraction optical element 901 can be shaped and mirror coated on the outside surface such that the light sampled by the light extraction optical element 901 is upon first incidence to a reflective surface of light extraction optical element 901, directed towards the central axis and upon second incidence on the second central reflective surface of the light extraction optical element 901, directed downwards towards to the optical sensor 902 centred inside a light collection optic 911, as illustrated by light ray 980. The light extraction optical element 901 can additionally prevent ambient light from entering the light collection optic 911. The light collection optic can further provide a means for directing the collected light towards the optical sensor and in one embodiment the light collection optic can additionally provide a means for further mixing the collected light. The walls of light collection optic 911, can be diffuse or specular reflective. The shape of the light extraction optical element 901 can allow for a greater amount of light to enter the light collection optic 911 while providing a desired level of ambient light rejection. As a result of the arrangement of the clusters 910, a substantially equal amount of light can be collected from each light-emitting element 903 and directed to optical sensor 902.

In another embodiment of the present invention, transparent lenses 912 associated with the optic 907 of each cluster and light extraction optical element 901 can be made from one piece of material, for example a polycarbonate or glass material or other suitable materials as would be known to a worker skilled in the art. This type of configuration can increase the amount of light transmitted to the light collection optic 911 by removal of one optical interface.

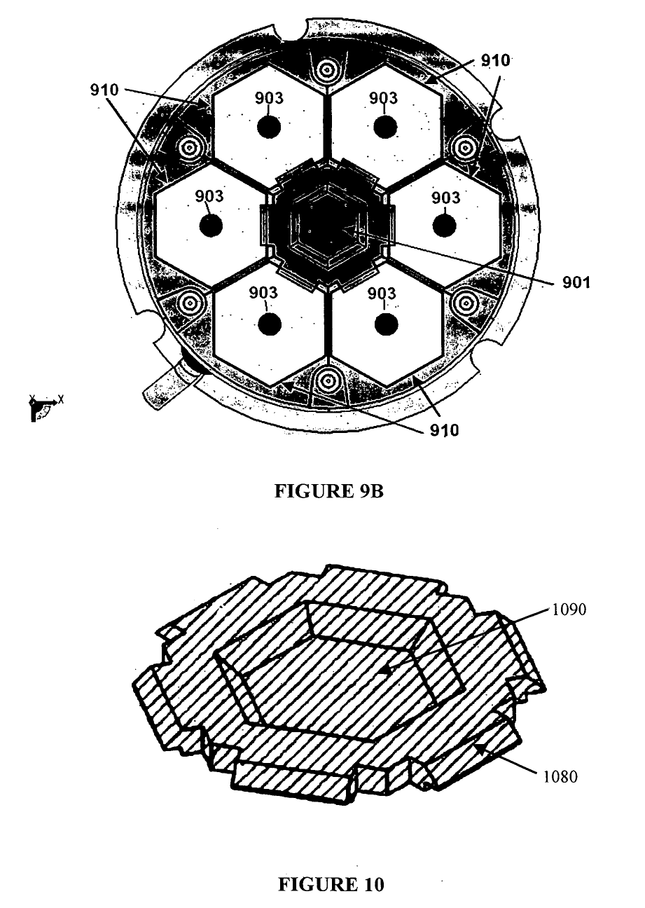

FIG. 10 illustrates a perspective view of the light extraction optical element 901 which can be positioned on the top of the light collection and redirection optic 911. This light extraction optical element comprises arms 1080 which mate with a portion of the cluster optic 907 or the lens 912 associated with the clusters of light-emitting elements. The arms 1080 provide a means for extraction of light from within the cluster optics. The depression 1090 in the light extraction optical element 901 is configured to aid in the redirection of the extracted light towards the optical sensor 902. In addition the top surface of the light extraction optical element 901 can reflectively coated and opaque. This configuration of the optical characteristics of light extraction optical element 901 can provide the redirection of collected light towards the optical sensor and can additionally aid in the rejection of ambient light from entering the light collection optic 911.

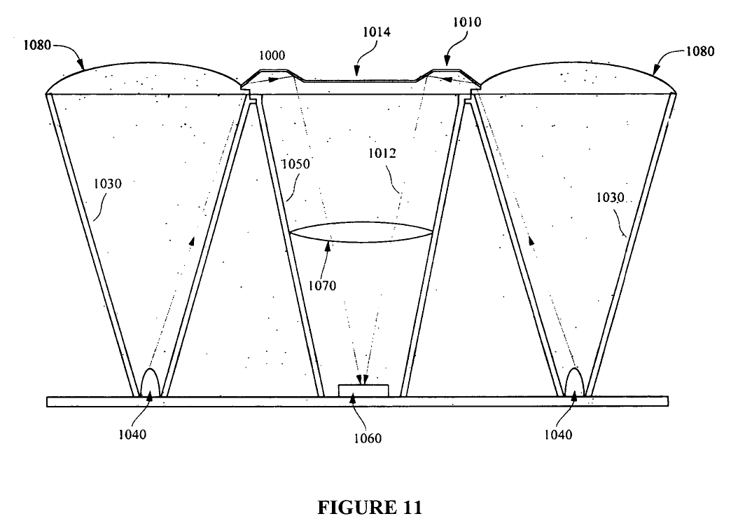

FIG. 11 illustrates one embodiment of the mating between light extraction optical element 1000 which forms the top of the light collection optic 1050, and the cluster optic 1030 and lens 1080 associated with a cluster of light-emitting elements 1040. Light emitted by the light emitting elements 1040 which is directed towards the light extraction optical element 1000 is extracted from cluster optic 1030 by the arm 1010 of light extraction optical element 1000. This extracted light 1012 is subsequently redirected by the depression 1014 within the light extraction optical element 1000, towards the optical sensor 1060 through the light collection optic 1050. The light collection optic 1050 may additionally provide a means for mixing the collected light prior to interaction with the optical sensor 1060. In order to aid with the extraction and redirection of the light extracted from the cluster optic 1030 associated with the cluster of light-emitting elements, the top surface of light extraction optical element 1000 can be formed as an opaque and reflective surface. In this manner, extracted light can be redirected towards the optical sensor 1060 and ambient light can be rejected from entering the light collection optic 1050.

In one embodiment of the present invention a filter 1070 can be placed inside the light collection optic 1050. The filter can be placed close to the optical sensor 1060 or at any desired position along the height of the light collection optic 1050. This filter can provide a means for limiting the amount of collected light that is directed towards the optical sensor 1060 or may selectively filter out undesired wavelengths of light. The filter 1070 can be a broadband neutral density filter to adjust the overall light level incident on the optical sensor 1060. The filter 1070 can alternately or additionally be a spectrally selective filter capable of selecting specific regions of the electromagnetic spectrum, for example infrared, ultraviolet or one or more regions of the visible spectrum. The filter can optionally provide the filtering characteristics of a combination of specific filter types.

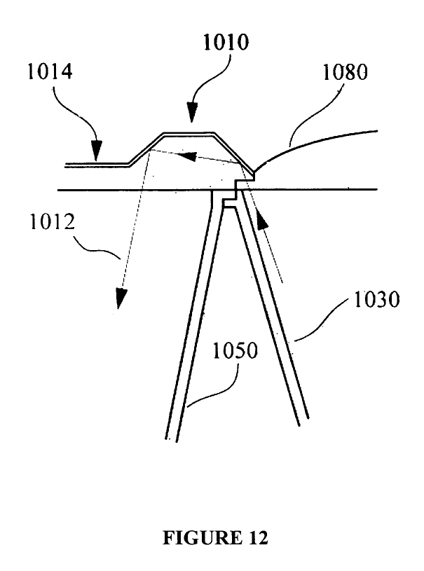

FIG. 12 illustrates a magnified view of the mating connection between light extraction optical element 1000 which encloses the light collection optic 1050, and the cluster optic 1030 and lens 1080 associated with a cluster of light-emitting elements, according to the embodiment illustrated in FIG. 11.

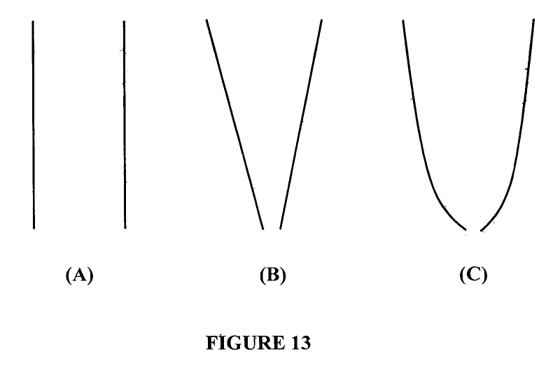

In one embodiment of the present invention, the light collection optic can be formed having a one of a variety of cross sectional shapes, for example circular, elliptical, square, hexagonal or other shape. The cross section shape may be dependent on the arrangement of the clusters of light emitting elements with which it is associated. In addition as illustrated in FIGS. 13A, 13B and 13C the longitudinal cross section of the light collection optic can be one or a variety of shapes for example rectangular, conical, or parabolic or other shape. The longitudinal cross sectional shape may be determined by the desired level of redirection of the collected light, the desired level of additional mixing of the collected light and the desired level of focusing of the redirected light.

In another embodiment of the present invention, a lens can be positioned at any location along the height of the light collection optic. The lens can provide a means for focusing the collected light onto the optical sensor.

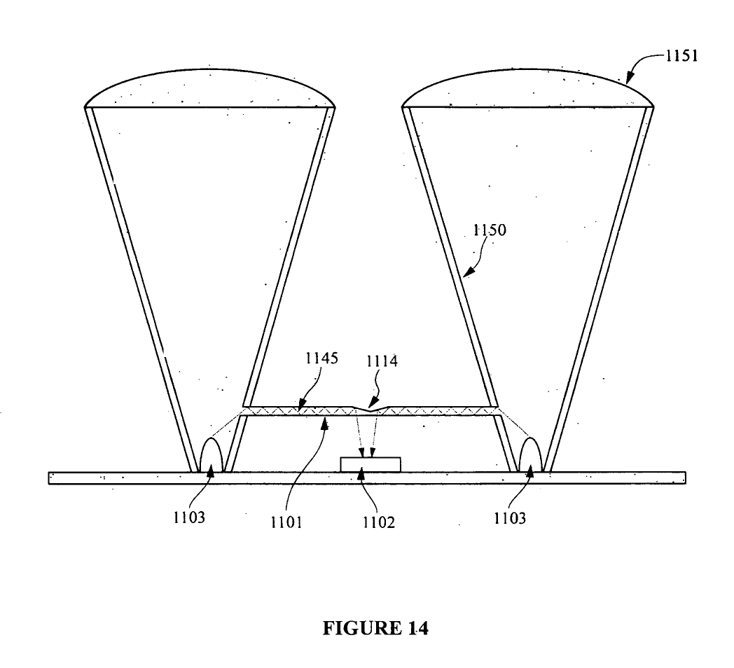

FIG. 14 illustrates another embodiment of an apparatus for collecting and detecting light according to the present invention. The light collection optic 1101 can be configured as a light guide and can be positioned proximate to the light-emitting elements 1103 and configured to pick up an amount of the light 1145 emitted by the light-emitting elements. In one embodiment the light collection optic 1101 is positioned at the base of the cluster optical element 1150 associated with the light-emitting elements 1103 and light collection optic 1101 provides a means for guiding the collected light by internal reflection there through towards an optical sensor 1102. The extraction location 1114 associated with the light collection optic 1101 which is positioned proximate to the location of the optical sensor 1102 is configured to direct this collected light towards the optical sensor 1102. This extraction location 1114 can comprise grooves, other surface formations or deformations which are configured to redirect the collected light towards the optical sensor 1102.

In one embodiment the light collection optic can function together with the cluster optical element associated with each cluster of light-emitting elements. The cluster optical element can be configured to extract an amount of light from the cluster and subsequently transmit this light to the light collection optic. In another embodiment, the light collection optic is positioned proximate to the interface between the light-emitting element cluster and the cluster optical element. The light collection optic can be configured to extract light which leaks from the interface between the cluster of light-emitting elements and the cluster optical element.

As would be readily understood, other configurations according to the present invention are possible. In addition, different configurations of the present invention may be desirable for different cluster designs. For example, due to the sensitivity of the sensor, a larger portion of light may be required by the sensor to obtain an acceptable signal-to-noise ratio and thus a configuration that allows collection of a larger portion of light may be desirable. As would be readily understood, other factors may govern the decision of which configuration of the present invention is used for particular applications.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. A lighting apparatus configured for light collection and detection, and adapted for connection to a source of power, said lighting apparatus comprising:
a) two or more clusters of one or more light-emitting elements for emission of light, said clusters arranged around a first central axis and each cluster is substantially equidistant from said first central axis;
b) light collection means for collection of a portion of the light emitted by each of the two or more clusters, said light collection means having a second central axis said light collection means positioned to align said second central axis with said first central axis; and
c) light detection means optically coupled to the light collection means, said light detection means for receiving said portion of light and conversion of said portion of light to an electrical signal representative of said light.

2. The lighting apparatus according to claim 1, wherein each of said clusters comprises a cluster optic.

3. The lighting apparatus according to claim 2, wherein said light collection means comprises an integrated feature formed with each said cluster optic, each said integrated feature configured to direct light from the cluster towards said light detection means.

4. The lighting apparatus according to claim 3, wherein said integrated feature is fabricated within the cluster optic.

5. The lighting apparatus according to claim 2, wherein said light collection means comprises a light extraction optic configured to mate with each cluster optic to extract said portion of light from each of said two or more clusters.

6. The lighting apparatus according to claim 2, wherein said light collection means comprises a light extraction optic optically coupled with said cluster optic for extraction of said portion of light from each cluster and guiding said portion of light to said light detection means.

7. The lighting apparatus according to claim 6, wherein said light collection means further comprises a light collection optic optically coupled to said light extraction optic, said light collection optic for directing the portion of light from each cluster towards the light detection means.

8. The lighting apparatus according to claim 7, wherein said light collection optic additionally mixes said portion of light from each cluster.

9. The lighting apparatus according to claim 7, wherein said light collection optic is a solid light pipe or a hollow light pipe.

10. The lighting apparatus according to claim 7, wherein said light collection optic comprises an optical lens for concentrating and/or focusing the portion of light from each cluster onto the light detection means.

11. The lighting apparatus according to claim 7, wherein the light collection optic comprises a filter.

12. The lighting apparatus according to claim 11, wherein said filter is a neutral filter or a selective filter.

13. The lighting apparatus according to claim 12, wherein said selective filter is an infrared filter, ultraviolet filter, or colour filter.

14. The lighting apparatus according to claim 1, wherein said light collection means comprises a light blocking element for limiting entrance of ambient light into the light collection means.

15. The lighting apparatus according to claim 1, wherein a filter is integrated into said light detection means.

16. The lighting apparatus according to claim 3, wherein a transparent lens is positioned on top of each of said cluster optic.

17. The lighting apparatus according to claim 16, wherein the light collection means comprises a light extraction optic configured to mate with the transparent lens on top of each cluster optic, said light extraction optic for extracting the portion of light from each of the clusters.

18. The light apparatus according to claim 17, wherein the light collection means further comprises a light collection optic optically coupled to the light extraction optic, said light collection optic for directing the portion of light from each cluster towards said light detection means.

19. The lighting apparatus according to claim 1, wherein said detection means comprises one or more optical sensors.

20. The lighting apparatus according to claim 19, wherein said one or more optical sensors are configured to detect light of one or more frequency ranges.

21. The lighting apparatus according to claim 19, wherein said one or more optical sensors are semiconductor photodiodes, photosensors, or LEDs.

22. A method for collecting and detecting light emitted by two or more clusters of light-emitting elements, said method comprising the steps of:
a) providing a light collection means optically coupled to the two or more clusters and a light detection means optically coupled to the light collection means, said two or more clusters arranged around a first central axis and each cluster substantially equidistant from said first central axis, said light collection means having a second central axis and said light collection means positioned to align said second central axis with said first central axis;
b) collecting a portion of light emitted by each of said two or more clusters of light emitting elements using said light collection means; and
c) detecting said portion of light and converting said portion of light to an electrical signal representative of said light using said light detection means.
